(19) United States
(12) Patent Application Publication
(10) Pub. No.: US 2002/0042000 A1
(43) Pub. Date: Apr. 11, 2002

(54) Ni/metal hydride secondary element

(75) Inventor: Peter Bauerlein, Lindwedel (DE)

Correspondence Address: Schnader Harrison Segal & Lewis, IP Department, 36th Floor, 1600 Market Street, Philadelphia, PA, 19103, US

(73) Assignee: NBT GmbH

(21) Appl. No.: 09/908,866

(22) Filed: Jul. 19, 2001

(30) Foreign Application Priority Data
Aug. 9, 2000 (DE) DE 100 38 789.6

(51) Int. Cl. H01M 4/62; H01M 4/52; H01M 4/32; B05D 5/12; H01M 4/58

(52) U.S. Cl. 429/232; 429/218.2; 429/223; 427/123

(57) ABSTRACT

A Ni/metal hydride secondary element having a positive nickel hydroxide electrode, a negative electrode which contains a hydrogen storage alloy, and an alkaline electrolyte, wherein the positive electrode, which is provided with a three-dimensional metallic conductive structure, also contains a nickel hydroxide whose grains are coated with discrete particles composed of metallic copper. The mass of the copper coating is about 0.2 to about 15 % by weight, preferably about 5 to about 10% by weight, of the mass of nickel hydroxide. The nickel hydroxide material coating is produced by non-electrical chemical deposition in an alkaline environment.

The Government of the United States of America has rights in this invention pursuant to cooperative Agreement No. DE-F C02-95EE 50425 awarded by the U.S. Department of Energy.

### FIELD OF THE INVENTION

This invention relates to batteries, particularly to a Ni/metal hydride secondary element having a positive nickel hydroxide electrode, a negative electrode which contains a hydrogen storage alloy, and an alkaline electrolyte as well as a method for producing positive electrodes for these secondary elements.

### BACKGROUND

Nickel hydroxide (Ni(OH)₂) represents the electrochemically active material of the positive electrode in nickel cadmium and nickel metal hydride batteries. Since bivalent nickel hydroxide does not conduct electrons, conductive agents in powder form are generally added. Thus, when the bulk material mixture is compressed, a three-dimensional conductive structure is formed which binds the nickel hydroxide particles with regard to electrons. In bulk material electrodes such as those used in button cells, fine nickel powder is added to the nickel hydroxide in order to obtain a conductive bulk material. In the past, graphite was used as the conductive agent in Ni/Cd cells. However, this was susceptible to destruction by oxidation. In electrodes with a metal foam structure, the nickel foam is used as the conductive structure, with its pores being filled with an aqueous suspension which contains nickel hydroxide.

It is known from EP 337029-B1 that an efficient conductive structure can be formed by adding cobalt compounds, such as CoO, Co(OH)₂ or Co metal. The Co compounds used are changed in the cell into electrically conductive CoOOH which electrically bonds onto the Ni(OH)₂ particles. Utilization of the bulk material of a positive bulk material electrode can thus be increased from approximately 200 mAh/g Ni(OH)₂ to 250 mAh/g Ni(OH)₂. The conductive structure formed by CoOOH is stable in “normal” operating conditions, that is to say, as long as the positive electrode is in the potential range above +350 mV vs. Hg/HgO.

If the potential of the positive electrode falls below 90 mV vs. Hg/HgO then reduction of the CoOOH may occur, particularly at an increased temperature.

Hydrogen evolves at the positive electrode if the potential of the positive electrode falls below −1.2 V vs. Hg/HgO. This leads to irreversible damage to the positive electrode. Such low potentials at the positive electrode can occur in the event of deep discharge. It is particularly damaging if the deep discharge occurs at increased temperatures. The so-called “HTSC test” (HTSC test=High Temperature Short Circuit test) simulates the situation of a deep discharge at increased temperatures. If a discharged NiMH cell containing CoO is short-circuited at an increased temperature, then the positive electrode is changed to the potential of the derated negative electrode, that is to say, approximately −0.9 V vs. Hg/HgO. This results in an irreversible capacity loss of 15 to 25% due to destruction of the CoOOH conductive structure and, possibly, destruction of the active material.

It is known from DE 44 37 787-A1 that destruction of the conductive structure which results from the HTSC test can be reduced by adding copper to the positive bulk material, in the form of its oxides or hydroxides, and/or in metallic form. Additives composed of Cu₂O and Cu(OH)₂ have been found to be particularly advantageous.

It is also known from EP 0 896 376-A1 that coating the nickel hydroxide particles with a mixed hydroxide composed of Co(OH)₂ and Cu(OH)₂ considerably reduces the HTSC effect. The advantage of a coating is that the effective agent is located in the ideal vicinity of the point where it acts, that is to say, on the surface of the Ni(OH)₂ grain.

It would accordingly be advantageous to reduce the loss of capacity of an Ni/metal hydride rechargeable battery after deep discharging.

### SUMMARY OF THE INVENTION

This invention relates to a Ni/metal hydride secondary element including a positive nickel hydroxide electrode, a negative electrode which contains a hydrogen storage alloy, an alkaline electrolyte, and a positive nickel hydroxide electrode having a three-dimensional metallic conductive structure and containing nickel hydroxide grains coated with discrete metallic copper particles.

In another aspect, this invention relates to a method of producing a nickel hydroxide electrode including non-electrically chemically depositing discrete copper particles on nickel hydroxide grains under alkaline conditions.

### BRIEF DESCRIPTION OF THE DRAWINGS

FIG. 1 is a cyclovoltamogram carried out on a pressed electrode with Cu.

FIG. 2 is a cyclovoltamogram carried out on a pressed electrode without Cu.

FIG. 3 is a graph showing the dependency of capacity C as a function of cycles Z.

FIG. 4 is a bar graph showing capacity change AC in Example 1 and Comparative Examples 1, 2 and 3.

### DETAILED DESCRIPTION

The method according to the invention for non-electrical deposition of copper on the surface of the nickel hydroxide grains results in conductive copper particles being produced on the surface of the Ni(OH)₂ particles. This avoids a random, statistical distribution of the copper in the positive electrode bulk material, as described in DE 44 37 787-A1. Since the surface of the Ni(OH)₂ particles is covered by a large number of copper particles and not by an impermeable Cu layer, the electrochemical reactions which take place during charging and discharging are not constrained. The copper coating or application of Cu particles according to the invention considerably reduces the capacity loss after deep discharging.

The electrically conductive copper layer formed from discrete particles on the nickel hydroxide grain is produced in particular by non-electrical deposition of copper from a solution containing alkaline, complexed copper ions, by means of a chemical reduction agent. The mass of the copper coating is about 0.2 to about 15% by weight, preferably about 5 to about 10% by weight, based on the weight of the nickel hydroxide.

It is known from coating technology that a metallic covering on non-metallic substrates (insulators) can be achieved only after pretreating the substrate surface. As a general rule, noble metal nuclei are produced on the surface of the insulator by means of processes which are known per se, and catalyze the kinetically constrained deposition reaction. Reduction of Cu⁺² to Cu using formaldehyde in accordance with the following expression has been known for a long time:

Cu⁺²+HCHO+3 OH⁻→Cu+HCOO⁻+2 H₂O.

The alkaline deposition bath according to the invention contains Cu⁺² ions made complex by means of tartrate ions. The process of forming complexes prevents copper hydroxide from being precipitated at the deposition pH value. Formaldehyde which is oxidized to form formiate, is used as the reduction agent. The deposition process is generally carried out at room temperature until all the Cu⁺² ions have been completely reduced.

A nickel hydroxide produced using this method and coated with metallic copper particles is advantageously used as an active material in a positive electrode of an Ni/metal hydride secondary element, since this ensures that important requirements such as the seating of the copper (which is used for deep-discharge protection) at the point where it acts, that is to say, on the surface of the grain, optimum distribution of the copper and high layer porosity, are satisfied.

During the cycling of an electrode having these characteristics, some of the metallic copper is oxidized during charging of the cell to form copper(II) oxide or hydroxide which, in the form of a hydroxo-complex, is soluble in the electrolyte. In the cell, residues of metallic copper are then located on the nickel hydroxide grain, components of Cu(OH)₂ in the positive electrode in the vicinity of and on the nickel hydroxide grain, and Cu⁺² ions dissolved in the form of a hydroxo-complex in the electrolyte. In the event of a deep discharge, the Cu⁺² compounds of the positive electrode are once again reduced to form metallic copper. The reactions which take place are formulated in the following text using the example of the reduction of CuO:

CuO+H₂O+2e→Cu+2OH⁻.

In a similar way to that with the CoOOH conductive structure, a conductive, three-dimensional network composed of metallic copper can thus be formed by the dissolving/deposition mechanism (dissolving of Cu(OH)₂, deposition of Cu during deep discharging) by the addition of copper, which network is stable particularly when the positive electrode is at a low potential, while, on the other hand, it is oxidized at a higher potential and in normal operating conditions. This represents an ideal supplement to that CoOOH conductive structure, which is likewise formed by a dissolving/deposition mechanism (dissolving of Co or CoO, deposition of CoOOH during charging of the cell), but which, in contrast to the Cu conductive structure, is stable in normal operating conditions but is reduced in deep-discharge conditions.

A nickel hydroxide coated with copper according to the invention may be produced as follows:

100 g (1.08 mol) of spherical nickel hydroxide is suspended for two minutes in a solution of 2.50 g (11. 1 mmoles) of tin(II) chloride and 10 ml of conc. (32%) hydrochloric acid in 250 ml of water. It is then sucked through a filter and washed three times with 100 ml of water before being dried by suction. The spherical nickel hydroxide pretreated in this way is suspended in 100 ml of water, and the suspension then has added to it a solution of 250 mg (1.74 mmoles) of palladium(II) chloride and 0.1 ml of conc. (32%) hydrochloric acid in 400 ml of water. This is stirred for two minutes at room temperature and then sucked through a filter, producing a colorless filtrate indicating that the palladium has been completely adsorbed on the nickel hydroxide. Washing is then carried out three times with 100 ml of water, followed by drying by suction.

39.2 g (157 mmoles) of copper(II) sulfate pentahydrate is dissolved in 1.3 1 of water in a 2 1 three-necked flask with a stirrer and gas extraction. 133 g (471 mmoles) of potassium sodium tartrate is then added, before 39.2 g (980 mmoles) of sodium hydroxide is added. 100 ml of 37% formaldehyde solution is added to the solution, which becomes deep blue. While stirring strongly, 100 g (1.08 moles) of pretreated nickel hydroxide is then introduced, at which point a strong reaction takes place immediately, with the color of the bath solution disappearing completely and the nickel hydroxide which is deposited being reddish brown. The remaining colorless solution is decanted and the precipitate obtained is formed into a sludge with 200 ml of water before being sucked through a filter. The coated Ni(OH)₂ is washed six times with 100 ml of water, before being dried in a vacuum desiccator over NaOH. This results in 105 g (105% with reference to the Ni(OH)₂) used of a powder which is now black after drying.

Chemical analysis of the resultant material gives a copper content of approximately 9%. The powder diffractogram has intensive signals at 2 [symbol] =43.4° and 50.4°, which are caused by metallic copper, in addition to the lines for nickel hydroxide. Signals also occur at 2 [symbol] =29.7°, 36.5° and 61.3°, and these are associated with Cu₂O. In REM photographs, Ni(OH)₂, spheres are visible, on which copper particles have grown, in the form of spherical agglomerates. The resistance of the material is determined on a pressed sample, after being pressed for a period of five minutes at a pressure of 20 kN/cm², at a frequency of 1000 Hz. The resistivity of the coated nickel hydroxide ρ is 5.9 Ω cm and is thus less by a factor of 8×10⁶ than that of an untreated nickel hydroxide.

The improved deep-discharge characteristics resulting from the use of the copper-coated nickel hydroxide according to the invention can be verified, for example, in button cells with bulk material electrodes. In such a case, the positive electrode contains either the nickel hydroxide according to the invention, or other nickel hydroxides for comparison purposes. In the work performed, the negative electrode was composed of a hydrogen storage alloy whose composition was of the ABs-type, LmNi_{3.6}Co_{0.7}Al_{0.4}Mn_{0.3} as well as 2% carbon black and 1% PTFE, and the mass was 2.20 g. The electrolyte used was 6.5 n KOH+0.5 n LiOH. Once the cells were assembled, they were first stored for three days at 45° C. They were then charged for 15 h at C/10, before being discharged at C/5 down to a final discharge voltage of 1.0 V. This was followed by 9 cycles of being charged for 7 hours at C/5 and discharged at C/5 down to 1.0 V. After these cycles, the discharged cells were short-circuited via a 2 ohm resistor and stored for three days at 60° C., the HTSC test. Five further charging/discharging cycles at C/5 were then carried out. The HTSC loss is given by the capacity before the HTSC test and the capacity after it.

### EXAMPLE 1 (B1)

The positive electrode was composed of 60% nickel hydroxide coated with copper according to the invention, 10% CoO and 30% Ni powder. The total mass was 1.80 g.

### COMPARISON EXAMPLE 1 (VI)

The positive electrode was composed of 60% nickel hydroxide, 10% CoO and 30% Ni powder. The total mass was 1.80 g.

### COMPARATIVE EXAMPLE 2 (V2)

The positive electrode was composed of 63% nickel hydroxide,3% CoO, 1% Co, 30% Ni powder and 3% Cu₂O as in DE 44 37 787-A1. The total mass was 1.80 g.

### COMPARATIVE EXAMPLE 3 (V3)

The positive electrode was in each case composed of 65% of a nickel hydroxide coated with a mixed hydroxide composed of cobalt and copper (Co_{0.97}Cu_{0.03}(OH)₂), 5% of CoO and 30% of Ni powder, as in EP 0 896 376. The total mass was 1.80 g.

The measurement of a cyclovoltamogram was carried out on pressed electrodes, which each contained 30% Ni powder as a conductive agent. Pressed electrodes as in Example 1 (with Cu) or as in Comparative Example 1 (without Cu) were used as positive electrodes. The positive pressed electrode was used as the main electrode with two Ni sheets being used as the opposing electrodes and an Hg/HgO electrode being used as the reference electrode. The rate of change was 0.1 mV/s.

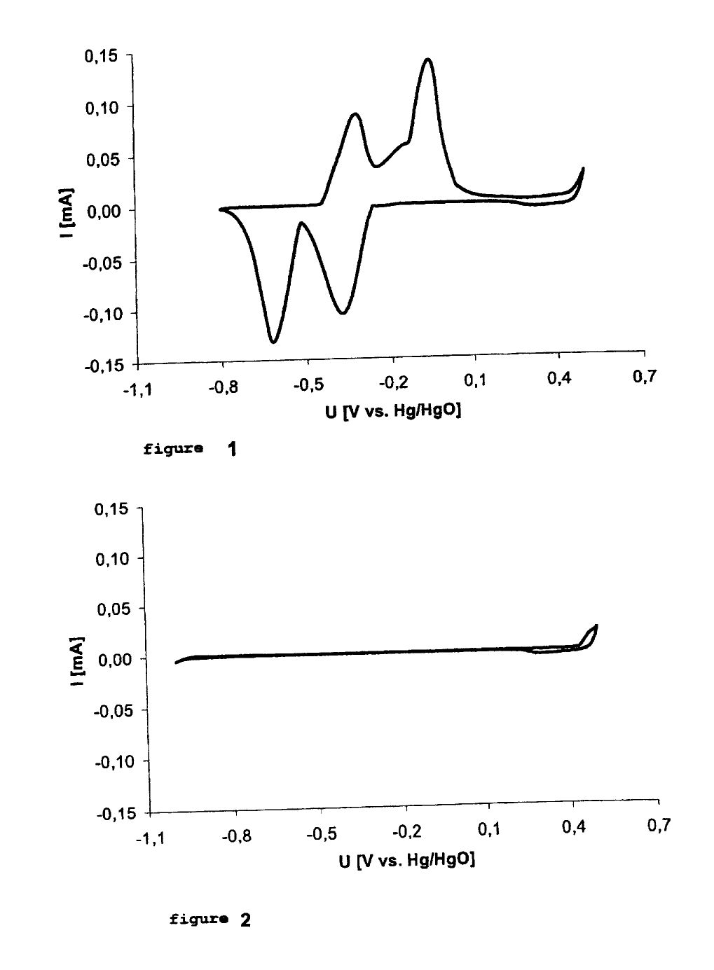

The Figures (FIG. 1 with Cu, FIG. 2 without Cu) each show the second scan. During the first scan, Cu⁺2 compounds were produced on the positive electrode, whose reduction and subsequent oxidation can be observed in the 2nd scan.

It can be seen from FIG. 1 that, in the case of the Cu-coated nickel hydroxide, redox reactions take place even before the potential required to produce hydrogen at the positive electrode is reached, with these redox reactions being due to the reduction of the Cu coating. In detail, these may be the reduction steps Cu (II)→Cu(I)→Cu.

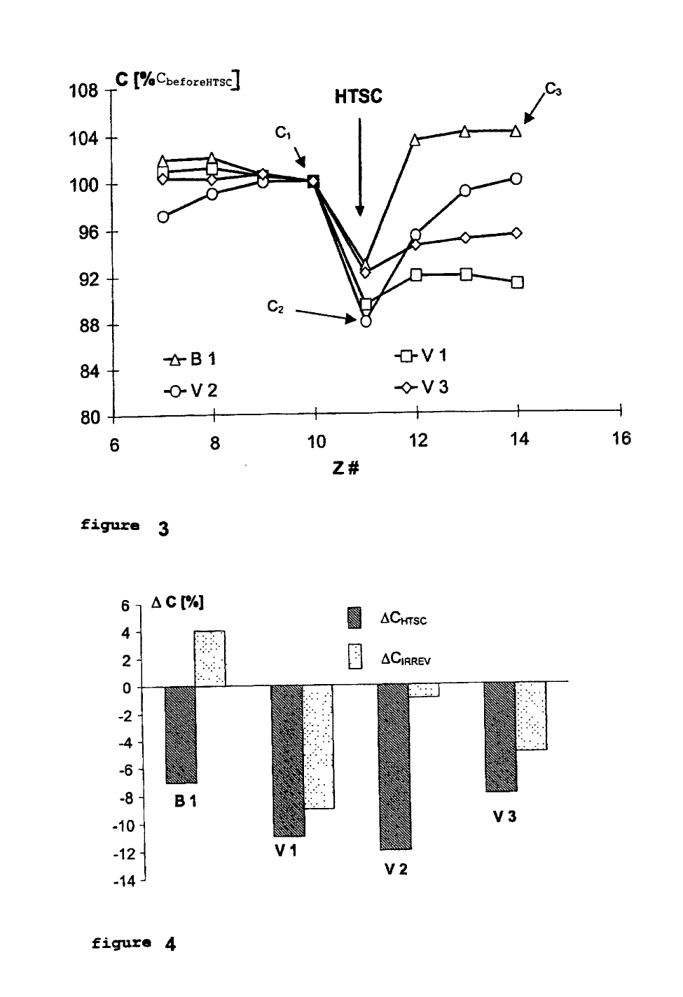

If the capacity of a cell before the HTSC storage is taken to be 100%, and the capacity immediately after HTSC storage is then determined, then it can be seen that the cell with the nickel hydroxide according to the invention has the highest capacity, at 93%. The total loss during HTSC storage is 7%, as Table 1 shows. FIG. 3 shows the dependency of the capacity C of the comparative cells with reference to the capacity before the HTSC test as a function of the number of cycles Z. The start of HTSC storage is indicated by the appropriate arrow in FIG. 3.

TABLE 1

| Nickel | C₁ | C₂ | C₃ | ΔC_{HTSC} | ΔC_{irrev.} |
|---|---|---|---|---|---|
| hydroxide | [%] | [%] | [%] | [%] | [%] |
| Example 1 (E1) | 100 | 93 | 104 | −7 | +4 |
| Comparison 1 (E1) | 100 | 89 | 91 | −11 | −9 |
| Comparison 2 (E2) | 100 | 88 | 99 | −12 | −1 |
| Comparison 3 (E3) | 100 | 92 | 95 | −8 | −5 |

where:

C₁ Capacity before HTSC storage, corresponding to 100%

C₂ Capacity immediately after HTSC storage

C₃ Regenerated capacity 3 cycles after HTSC storage

ΔC_{HTSC}: Total capacity change during HTSC storage

ΔC_{irrev.}: Irreversible capacity change remaining after HTSC storage

Table 1 also shows that the cells recover after a few cycles following the HTSC and thus regain some of their capacity. One exception is formed by those cells with the nickel hydroxide according to the invention whose capacity after a number of regeneration cycles after HTSC storage is approximately 4% greater than before HTSC storage. There is an irreversible remaining capacity loss of 1 to 9% in all the comparative examples. This can be seen in FIG. 4, which shows the total capacity change ACHTSC and the irreversible capacity change ΔC_{IRREV} in the examples.

Cells with the nickel hydroxide coated according to the invention achieve 104% of their capacity before storage after HTSC storage, thus, in comparison with the comparative examples, they have the greatest capacity after the HTSC test, since a copper conductive structure is formed during the HTSC storage.

1. A Ni/metal hydride secondary element comprising:
a positive nickel hydroxide electrode,
a negative electrode which contains a hydrogen storage alloy,
an alkaline electrolyte, and
a positive nickel hydroxide electrode having a three-dimensional metallic conductive structure and containing nickel hydroxide grains coated with discrete metallic copper particles.

2. The Ni/metal hydride secondary element as claimed in claim 1, wherein the weight of the coating of copper is about 0.2 to about 15% by weight based on the weight of nickel hydroxide.

3. The Ni/metal hydride secondary element as claimed in claim 1, wherein the weight of the coating of copper is about 5 to about 10% by weight based on the weight of nickel hydroxide.

4. The Ni/metal hydride secondary element as claimed in claim 1, wherein the copper particles are chemically deposited on the nickel hydroxide grains.

5. The Ni/metal hydride secondary element as claimed in claim 2, wherein the copper particles are chemically deposited on the nickel hydroxide grains.

6. The Ni/metal hydride secondary element as claimed in claim 3, wherein the copper particles are chemically deposited on the nickel hydroxide grains.

7. A button cell formed from a Ni/metal hydride secondary element comprising:
a positive nickel hydroxide electrode,
a negative electrode which contains a hydrogen storage alloy,
an alkaline electrolyte, and
a positive nickel hydroxide electrode having a three-dimensional metallic conductive structure and containing nickel hydroxide grains coated with discrete metallic copper particles.

8. A battery formed from a Ni/metal hydride secondary element comprising:
a positive nickel hydroxide electrode,
a negative electrode which contains a hydrogen storage alloy,
an alkaline electrolyte, and
a positive nickel hydroxide electrode having a three-dimensional metallic conductive structure and containing nickel hydroxide grains coated with discrete metallic copper particles.

9. A method for producing a nickel hydroxide electrode for an Ni/metal hydride secondary element as claimed in claim 1, comprising applying discrete copper particles to the nickel hydroxide grains by non-electrical chemical deposition in an alkaline environment.

10. A method for producing a nickel hydroxide electrode for an Ni/metal hydride secondary element as claimed in claim 2, comprising applying discrete copper particles to the nickel hydroxide grains by non-electrical chemical deposition in an alkaline environment.

11. A method for producing a nickel hydroxide electrode for an Ni/metal hydride secondary element as claimed in claim 3, comprising applying discrete copper particles to the nickel hydroxide grains by non-electrical chemical deposition in an alkaline environment.

12. The method as claimed in claim 9, wherein copper is deposited from an alkaline solution containing complexed copper ions by a chemical reduction agent.

13. The method as claimed in claim 10, wherein copper is deposited from an alkaline solution containing complexed copper ions by a chemical reduction agent.

14. The method as claimed in claim 11, wherein copper is deposited from an alkaline solution containing complexed copper ions by a chemical reduction agent.

15. A method of producing a nickel hydroxide electrode comprising non-electrically chemically depositing discrete copper particles on nickel hydroxide grains under alkaline conditions.
